(19) United States
(12) Patent Application Publication
(10) Pub. No.: US 2024/0329904 A1
(43) Pub. Date: Oct. 3, 2024

(54) ELECTRONIC DEVICE AND CONTROL METHOD THEREOF

(71) Applicant: CARUX TECHNOLOGY PTE. LTD., SINGAPORE (SG)

(72) Inventor: Yi-Cheng CHANG, Tainan (Tainan Science Park) (TW)

(21) Appl. No.: 18/584,160

(22) Filed: Feb. 22, 2024

(30) Foreign Application Priority Data
Mar. 30, 2023 (CN) 202310326311.6

(51) Int. Cl. G06F 3/14; G09G 5/36

(52) U.S. Cl. CPC G06F 3/14; G09G 5/36; G09G 2330/021

(57) ABSTRACT

An electronic device includes a display panel, a first control element, and a second control element. The display panel has a first display area and a second display area. The display panel displays in a first display mode or a second display mode. The first control element controls the first display area. The second control element controls the second display area. The second control element includes a first sub-control unit and a second sub-control unit. When the display panel displays in the second display mode, the first sub-control unit is disabled, and the second sub-control unit is enabled.

### CROSS REFERENCE TO RELATED APPLICATIONS

This application claims the benefit of China Application No. 202310326311.6, filed on Mar. 30, 2023, the entirety of which is incorporated by reference herein.

### BACKGROUND OF THE DISCLOSURE

### Field of the Invention

The present invention relates to an electronic device, and, in particular, to an electronic device for reducing display power consumption and a control method thereof.

### Description of the Related Art

When a general monitor displays a black screen, a timing controller (T-CON) still needs to provide black screen data to a driver, and the driver still needs to activate its digital-to-analog converter (DAC) to generate a black screen, which consumes more power. For multi-screen displays, such as large automotive displays, no matter how many screens it displays, when one of the screens is a black screen, the driver that provides the black screen still needs to be powered on and provided with data.

### BRIEF SUMMARY OF THE DISCLOSURE

An embodiment of the present disclosure provides an electronic device. The electronic device includes a display panel, a first control element, and a second control element. The display panel has a first display area and a second display area. The display panel displays in a first display mode or a second display mode. The first control element controls the first display area. The second control element controls the second display area. The second control element includes a first sub-control unit and a second sub-control unit. When the display panel displays in the second display mode, the first sub-control unit is disabled, and the second sub-control unit is enabled.

An embodiment of the present disclosure also provides a method for controlling an electronic device. The method includes the following stages. The electronic device is provided. The electronic device includes a display panel, a first control element, and a second control element. The second control element includes a first sub-control unit and a second sub-control unit. The display panel includes a first display area and a second display area. The display panel displays in a first display mode or a second display mode. Display steps to cause the display panel to display are performed. The first control element is used to control the first display area. The second control element is used to control the second display area. When the display panel displays in the first display mode, the display steps include the following stage. The first sub-control unit is enabled and the second sub-control unit is disabled. When the display panel displays in the second display mode, the display steps include the following stage. The first sub-control unit is disabled and the second sub-control unit is enabled.

### BRIEF DESCRIPTION OF THE DRAWINGS

The disclosure can be more fully understood by reading the subsequent detailed description with references made to the accompanying figures. It should be understood that the figures are not drawn to scale in accordance with standard practice in the industry. In fact, it is allowed to arbitrarily enlarge or reduce the size of components for clear illustration. This means that many special details, relationships and methods are disclosed to provide a complete understanding of the disclosure.

FIG. 1 is a schematic diagram of an electronic device 100 in accordance with some embodiments of the present disclosure.

FIG. 2 is a schematic diagram of an electronic device 200 in accordance with some embodiments of the present disclosure.

FIG. 3 is a schematic diagram of an electronic device 300 in accordance with some embodiments of the present disclosure.

FIG. 4 is a simple schematic diagram of an electronic device 400 in accordance with some embodiments of the present disclosure.

FIG. 5 is a schematic diagram of an electronic device 500 in accordance with some embodiments of the present disclosure.

FIG. 6 is a schematic diagram of a black voltage generator 600 to generate a black screen signal BL50 in FIG. 5 in accordance with some embodiments of the present disclosure.

FIG. 7 is a simple schematic diagram of an electronic device 700 in accordance with some embodiments of the present disclosure.

FIG. 8 is a simple schematic diagram of an electronic device 800 in accordance with some embodiments of the present disclosure.

FIG. 9 is a simple schematic diagram of an electronic device 900 in accordance with some embodiments of the present disclosure.

FIG. 10 is a schematic diagram of an electronic device 1000 in accordance with some embodiments of the present disclosure.

FIG. 11 is a schematic diagram of an electronic device 1100 in accordance with some embodiments of the present disclosure.

FIG. 12A is a schematic diagram of a touch function circuit 1200 in the electronic device 1100 in FIG. 11 in accordance with some embodiments of the present disclosure.

FIG. 12B is a schematic diagram of a transmit buffer 1210 in accordance with some embodiments of the present disclosure.

FIG. 13 is a simple schematic diagram of an electronic device 1300 in accordance with some embodiments of the present disclosure.

FIG. 14 is a flow chart of a method for controlling an electronic device in accordance with some embodiments of the present disclosure.

### DETAILED DESCRIPTION OF THE DISCLOSURE

In order to make the above purposes, features, and advantages of some embodiments of the present disclosure more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present disclosure are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear, “back”, “left”, “right”, etc., are only directions referring to the drawings. Therefore, the directional terms are used for explaining and not used for limiting the present disclosure. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present disclosure.

In the present disclosure, the electronic device may include a display device, a backlight device, an antenna device, a sensing device, or a splicing device, etc., but is not limited thereto. The electronic device may be a bendable or flexible electronic device. The display device may be a non-self-luminous display device or a self-luminous display device. The antenna device may be a liquid-crystal antenna device or a non-liquid-crystal antenna device, and the sensing device may be a sensing device for sensing capacitance, light, heat, or ultrasonic waves, but is not limited thereto. The electronic components may include passive and active components, such as capacitors, resistors, inductors, diodes, transistors, and the like. The diodes may include light-emitting diodes or photodiodes. The light-emitting diode may include organic light-emitting diode (OLED), inorganic light-emitting diode, micro-LED, mini-LED, quantum dot light-emitting diode (QLED, QDLED), other suitable materials or a combination of the above materials, but is not limited thereto. The splicing device may be, for example, a splicing display device or a splicing antenna device, but is not limited thereto. In addition, the display device in the electronic device may be a color display device or a monochrome display device, and the shape of the electronic device may be rectangular, circular, polygonal, a shape with curved edges, or other suitable shapes. In addition, the electronic device described below uses, as an example, the sensing of a touch through an embedded touch device, but the touch-sensing method is not limited thereto, and another suitable touch-sensing method can be used provided that it meets all requirements.

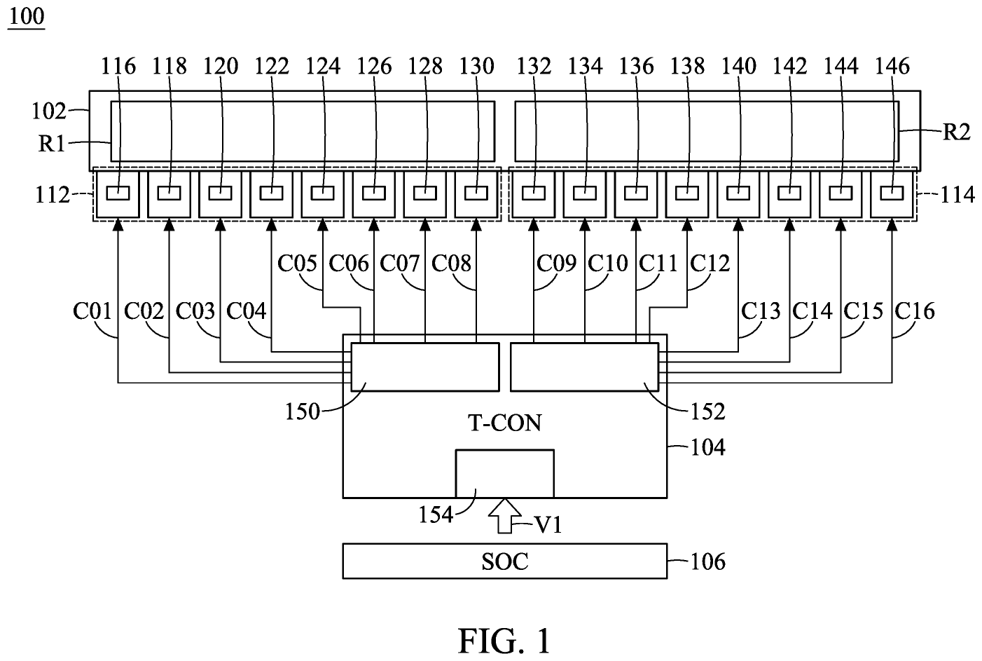

FIG. 1 is a schematic diagram of an electronic device 100 in accordance with some embodiments of the present disclosure. As shown in FIG. 1, the electronic device 100 includes a display panel 102, a timing controller (T-CON) 104, an image processor (SOC) 106, a first control element group 112, and a second control element group 114. In some embodiments, the electronic device 100 is a vehicle display module, but the present disclosure is not limited thereto. In some embodiments, the display panel 102 includes a first display area R1 and a second display area R2. The display panel 102 displays in a first display mode or a second display mode. In some embodiments, the first display area R1 is disposed in front of the driver's seat of the vehicle, and the second display area R2 is disposed in front of the passenger seat of the vehicle, but the present disclosure is not limited thereto. The first control element group 112 controls the first display area R1. The second control element group 114 controls the second display area R2. In some embodiments, the first control element group 112 includes a plurality first control elements, for example, including a first control element 116, a first control element 118, a first control element 120, and a first control element 122, a first control element 124, a first control element 126, a first control element 128, and a first control element 130. The second control element group 114 includes a plurality second control elements, for example, including a second control element 132, a second control element 134, a second control element 136, a second control element 138, a second control element 140, a second control element 142, a second control element 144, and a second control element 146.

As shown in FIG. 1, in some embodiments, the timing controller 104 is electrically connected to the display panel 102. The timing controller 104 includes a transmitting interface 150, a transmitting interface 152, and a receiving interface 154. The timing controller 104 sends the image signal to all the control elements in the first control element group 112 through the transmitting interface 150, and sends the image signal to all the control elements in the second control element group 114 through the transmitting interface 152.

In some embodiments, the timing controller 104 sends a plurality of sub-control signals to a plurality of first control elements in the first control element group 112 respectively through the transmitting interface 150. Specifically, the timing controller 104 sends the sub-control signals C01 to C08 to the first control elements 116, 118, 120, 122, 124, 126, 128, and 130 respectively through the transmitting interface 150. In some embodiments of FIG. 1, the first control elements 116, 118, 120, 122, 124, 126, 128, and 130 in the first control element group 112 are respectively turned on according to the sub-control signals C01 to C08, so that the first display area R1 displays the corresponding screen when the display panel 102 displays in the second display mode.

Similarly, in some embodiments of FIG. 1, the timing controller 104 sends a plurality of sub-control signals to a plurality of second control elements in the second control element group 114 respectively through the transmitting interface 152. Specifically, the timing controller 104 sends the sub-control signals C09 to C16 to the second control elements 132, 134, 136, 138, 140, 142, 144, and 146 respectively through the transmitting interface 152. In some embodiments of FIG. 1, the second control elements 132, 134, 136, 138, 140, 142, 144, and 146 in the second control element group 114 are respectively turned off according to the sub-control signals C09 to C16, so that the second display area R2 displays a black screen when the display panel 102 displays in the second display mode. In some embodiments, the timing controller 104 receives an image signal V1 from the image processor 106 through the receiving interface 154. In some embodiments, the image processor 106 is electrically connected to the timing controller 104. The image signal transmitted by the timing controller 104 through the transmitting interface 150 and the transmitting interface 152 is related to the image signal V1 from the image processor 106.

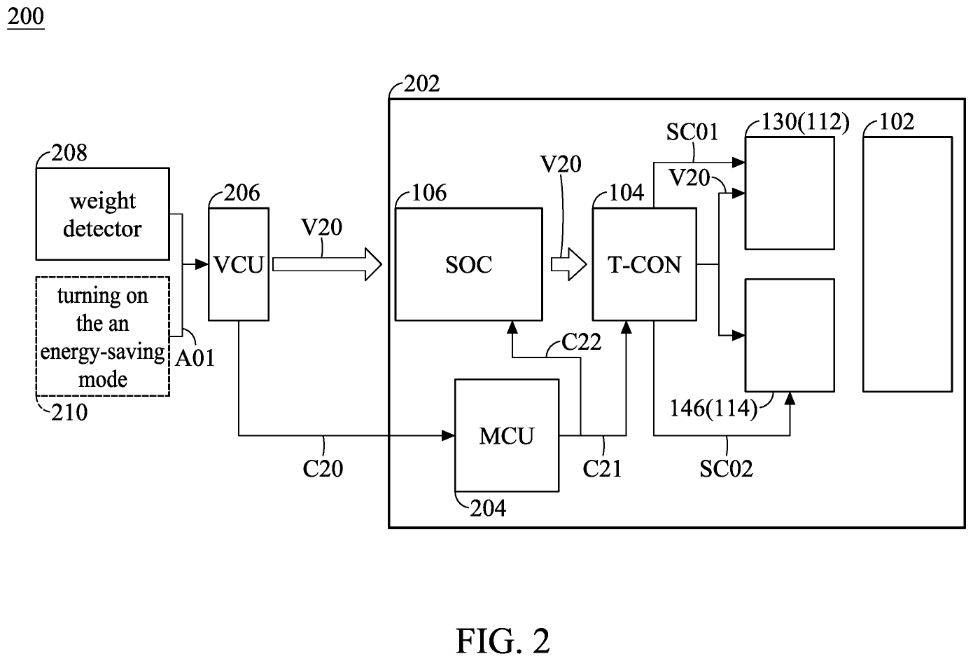

FIG. 2 is a schematic diagram of an electronic device 200 in accordance with some embodiments of the present disclosure. As shown in FIG. 2, the electronic device 200 includes a display module 202, a vehicle control unit (VCU) 206, and a weight detector 208. In some embodiments, the display module 202 includes a display panel 102, a timing controller 104, an image processor 106, a first control element 130, a second control element 146, and a third control element (MCU) 204. For convenience of explanation, the first control element group 112 in FIG. 1 is illustrated in FIG. 2 by the first control element group including one first control element 130, but the present disclosure is not limited thereto. The second control element group 114 in FIG. 1 is illustrated in FIG. 2 by the second control element group including one second control element 146. According to some embodiments, the first control element 130 controls the first display area R1 of the display panel 102, and the second control element 146 controls the second display area R2 of the display panel 102.

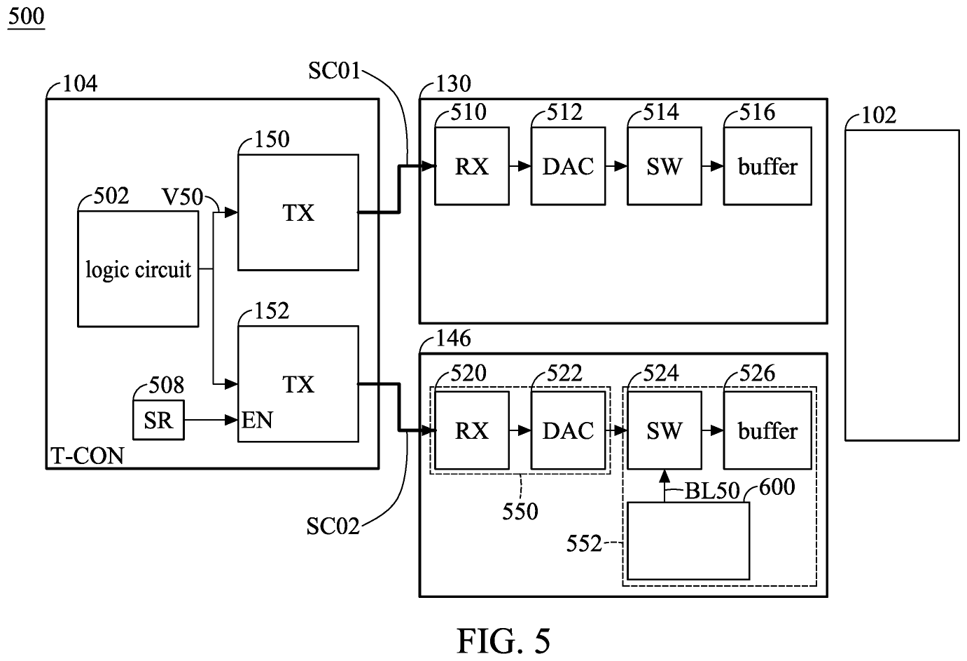

As shown in FIG. 2, the third control element 204 is electrically connected to the timing controller 104 to output a control signal C21 to the timing controller 104. In some embodiments, the weight detector 208 may, for example, be disposed under the passenger seat to detect whether someone is seated. In some embodiments, the vehicle control unit 206 may have a function of turning on the energy-saving mode 210, but the present disclosure is not limited thereto. For example, the display panel 102 in FIG. 2 may display a user interface including a virtual button, or a physical button may be disposed in the vehicle. When the user presses the virtual button displayed on the display panel 102 or the physical button in the vehicle, the function of turning on the energy-saving mode 210 may be performed. In some embodiments, when the weight detector 208 detects that no one is seated, and/or the energy-saving mode 210 of the vehicle control unit 206 is turned on, the vehicle control unit 206 receives a notification signal A01 and outputs a control signal C20 to the third control element 204 in the display module 202. Therefore, the display module 202 is informed to activate the energy-saving mode, and/or the display panel 102 is informed to display in the second mode. The vehicle control unit 206 also continues to output an image signal V20 to the image processor 106 in the display module 202. Next, after receiving the control signal C20 from the vehicle control unit 206, the third control element 204 outputs a control signal C21 to the timing controller 104 and a control signal C22 to the image processor 106 to inform the timing controller 104 and the image processor 106 to activate the energy-saving mode. After receiving the control signal C21 from the third control element 204, the timing controller 104 outputs a sub-control signal SC02 to the second control element 146 according to the control signal C21, and outputs a sub-control signal SC01 to the first control element 130. When the display panel 102 is turned off or partially turned off, the first control element 130 turns off parts of circuit functions in the first control element 130 according to the sub-control signal SC01, and the second control element 146 turns off parts of circuit functions in the second control element 146 according to the sub-control signal SC02 to achieve the purpose of power saving. According to some embodiments, in the second display mode, referring to FIG. 5, the timing controller 104 outputs the sub-control signal SC02 to the second control element 146 according to the control signal C21. Therefore, the first sub-control unit 550 in the second control element 146 is disabled (turned off), and the second sub-control unit 552 is enabled. Since the first sub-control unit 550 in the second control element 146 is disabled, the purpose of power saving can be achieved.

In some embodiments, after receiving the image signal V20 from the vehicle control unit 206, the image processor 106 outputs the image signal V20 to the timing controller 104. Then, the timing controller 104 sends the image signal V20 to the first control element 130 and the second control element 146. In some embodiments, when the display panel 102 displays in the first display mode or the second display mode, the first control element 130 outputs a first driving signal to the display panel 102 according to the image signal V20, and the second control element 146 outputs a second driving signal to the display panel 102 according to the image signal V20, so that the display panel 102 displays the corresponding image.

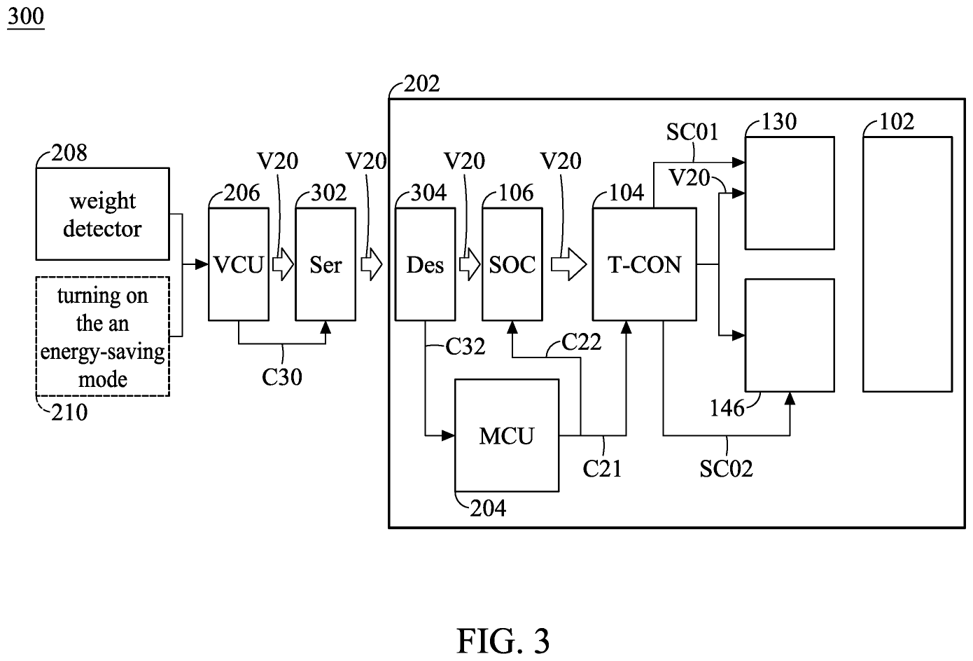

FIG. 3 is a schematic diagram of an electronic device 300 in accordance with some embodiments of the present disclosure. The difference between the electronic device 300 in FIG. 3 and the electronic device 200 in FIG. 2 is that the electronic device 300 in FIG. 3 further includes a serializer (Ser) 302 and a deserializer (Des) 304. As shown in FIG. 3, the serializer 302 is disposed between the vehicle control unit 206 and the deserializer 304 in the display module 202. The deserializer 304 is disposed between the serializer 302 and the image processor 106 in the display module 202. In some embodiments, when the weight detector 208 detects that no one is seated, and/or the energy-saving mode of the vehicle control unit 206 is turned on, the vehicle control unit 206 outputs the control signal C30 to the serializer 302. The vehicle control unit 206 continues to output the image signal V20 to the serializer 302.

In some embodiments, the serializer 302 encodes the image signal V20 and sends the encoded image signal V20 to the deserializer 304 in the display module 202. Similarly, the serializer 302 also sends the control signal C30 from the vehicle control unit 206 to the deserializer 304. The deserializer 304 decodes the encoded image signal V20 and sends the image signal V20 to the image processor 106. After receiving the control signal C30 from the serializer 302, the deserializer 304 outputs the control signal C32 to the third control component 204 to inform the display module 202 to activate the energy-saving mode. In some embodiments, the serializer 302 and the deserializer 304 extend the transmission distance of the image signal V20, but the present disclosure is not limited thereto.

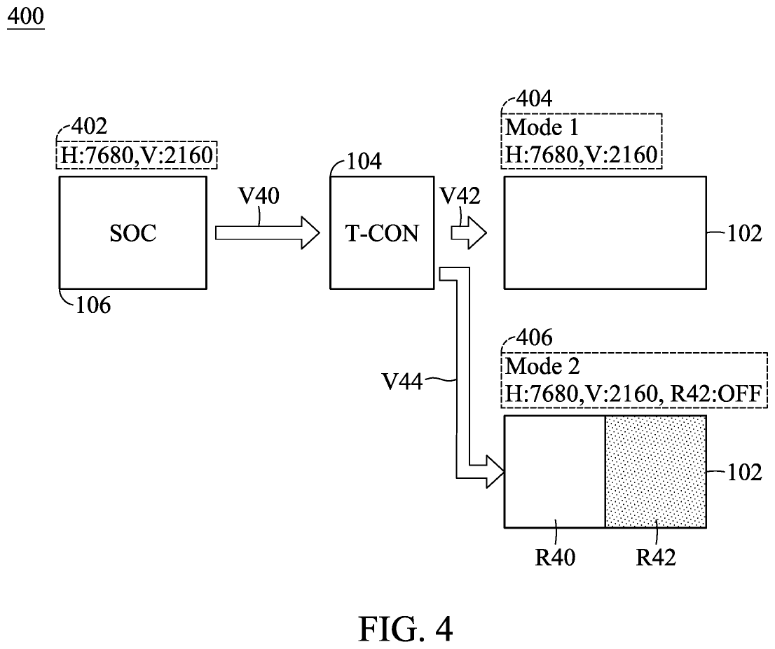

FIG. 4 is a simple schematic diagram of an electronic device 400 in accordance with some embodiments of the present disclosure. The electronic device 400 includes the display panel 102, the timing controller 104, and the image processor 106. FIG. 4 illustrates the resolution change of the image signal from the image processor 106 to the display panel 102, so some components in FIG. 1 and FIG. 2 are omitted. For example, the first control element group 112 and the second control element group 114 in FIG. 1 are omitted. According to some embodiments, the electronic device 400 in FIG. 4 may include the components described in FIG. 1 and FIG. 2, which will not be described again herein.

As shown in FIG. 4, the timing controller 104 is electrically connected to the display panel 102, and the image processor 106 is electrically connected to the timing controller 104. The image signal received by the image processor 106 conforms to the resolution setting 402, that is, the horizontal resolution is 7680 and the vertical resolution is 2160 (H:7680, V:2160). The image processor 106 outputs the image signal V40 and sends the image signal V40 to the timing controller 104. The image signal V40 therefore also conforms to the resolution setting 402. In some embodiments, in a normal mode, the display panel 102 displays in the first display mode. In the energy-saving mode, the display panel 102 displays in the second display mode. The image signal V40 may include a first image signal V42 and a second image signal V44. According to some embodiments, when the display panel 102 displays in the first display mode, the timing controller 104 outputs the first image signal V42 to the display panel 102. In the first display mode (Mode 1), the energy-saving mode is not turned on, and the image signal V42 conforms to the resolution setting 404, that is, the horizontal resolution is 7680 and the vertical resolution is 2160 (H:7680, V:2160). When the display panel 102 displays in the second display mode, the timing controller 104 outputs the second image signal V44 to the display panel 102. That is, in the second display mode (Mode 2), the image processor 106 outputs the second image signal V44 to the timing controller 104. Since the energy-saving mode is turned on, the second image signal V44 conforms to the resolution setting 406, that is, the horizontal resolution is 7680 and the vertical resolution is 2160 (H:7680, V:2160), the timing controller 104 outputs a sub-control signal to turn on the control units corresponding to the first display area R40 (i.e., the first control element group 112 in FIG. 1), but to partially turn off the control units corresponding to the second display area R42 (R42:OFF). According to some embodiments, as shown in FIG. 4, the first image signal V42 and the second image signal V44 may be different. According to some embodiments, as shown in FIG. 4, the resolution of the first image signal V42 is the same as the resolution of the second image signal V44, for example, both are (H:7680, V:2160).

As shown in FIG. 4, in the second display mode, the display panel 102 receives the second image signal V44 that conforms to the resolution setting 406. However, the control unit corresponding to the second display area R42 is partially turned off based on the sub-control signal SC02, so the display panel 102 displays the corresponding image in the first display area R40 according to the second image signal V44, and displays a black screen in the second display area R42. In some embodiments of FIG. 4, the image signal received by the image processor 106 may, for example, come from the vehicle control unit 206 in FIG. 2. In some embodiments of FIG. 4, the timing controller 104 can preset two modes, which are switched by the vehicle control unit 206, while the resolution of the image signal output by the vehicle control unit 206 to the image processor 106 remains unchanged.

FIG. 5 is a schematic diagram of an electronic device 500 in accordance with some embodiments of the present disclosure. As shown in FIG. 5, the electronic device 500 includes the panel 102, the timing controller 104, the first control element 130, and the second control element 146. FIG. 5 illustrates some embodiments in which the timing controller 104 controls the first control element 130 and partially turns off the second control element 146, so the image processor 106 and other control units are omitted. As shown in FIG. 5, the timing controller 104 includes a transmitting interface (TX) 150, a transmitting interface (TX) 152, a logic circuit 502, and a register (SR) 508. The first control element 130 includes a receiving interface (RX) 510, a digital-to-analog convertor (DAC) 512, a switch (SW) 514, and a buffer 516. The second control element 146 includes a first sub-control unit 550 and a second sub-control unit 552. The first sub-control unit 550 includes a receiving interface 520 and a digital-to-analog converter 522. Digital-to-analog converter 522 includes a switch 524, a buffer 526, and a black voltage generator 600. When the timing controller 104 receives the control signal to turn on the energy-saving mode (for example, no one is sitting in the passenger seat), that is, the timing controller 104 controls the display panel 102 to display in the second display mode, the logic circuit 502 outputs the image signal V50 to the transmitting interface 150, and the transmitting interface 150 sends the image signal V50 to the receiving interface 510 of the first control element 130. The first control element 130 controls the first display area R1 of the display panel 102 (as shown in FIG. 1). The image signal V50 is converted into an image analog signal through the digital-to-analog converter 512. Since the first control element 130 receives the sub-control signal SC01 from the timing controller 104 without activating the energy-saving mode, the switch 514 receives the image analog signal and sends the image analog signal to the buffer 516. Afterwards, the image analog signal is used to drive the first display area in the display panel 102.

As shown in FIG. 5, the following describes the situation of driving the second display area of the display panel 102 in the second display mode. When the timing controller 104 receives a control signal to turn on the energy-saving mode (for example, no one is sitting in the passenger seat), that is, the timing controller 104 controls the display panel 102 to display in the second display mode, the register 508 outputs the control signal to an enable terminal EN of the transmitting interface 152, so that the transmitting interface 152 is turned off. Therefore, the transmitting interface 152 does not receive the image signal V50 from the logic circuit 502. The timing controller 104 outputs the control signal SC02 to the second control element 146 so that the first sub-control unit 550 is disabled (turned off) and the second sub-control unit 552 is enabled (turned on). The second control element 146 controls the second display area R2 of the display panel 102 (as shown in FIG. 1). Since the second sub-control unit 552 is enabled, the switch 524 receives the black screen signal BL50 through a signal line, and the switch 524 outputs the black screen signal BL50 to the buffer 526. In some embodiments, the black screen signal BL50 is derived from the black voltage generator 600. The signal line may be a power line, for example. The black screen signal BL50 is output to the display panel 102, so that the second display area of the display panel 102 displays a black screen. According to some embodiments, when the display panel 102 displays in the second display mode, the second sub-control unit 552 generates the black screen signal BL50. To put it simply, when no one is sitting in the passenger seat or the energy-saving mode is turned on, since the transmitting interface 152, the receiving interface 520, and the digital-to-analog converter 522 of the timing controller 104 are all turned off, the purpose of saving power consumption can be achieved. According to some embodiments, when the display panel 102 displays in the second display mode, the first sub-control unit 550 is disabled and the second sub-control unit 552 is enabled.

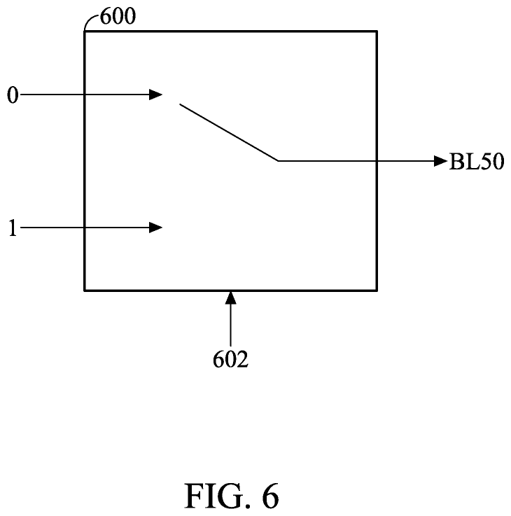

FIG. 6 is a schematic diagram of a black voltage generator 600 to generate a black screen signal BL50 in FIG. 5 in accordance with some embodiments of the present disclosure. As shown in FIG. 6, the black voltage generator 600 switches between the negative polarization voltage 0 and the positive polarization voltage 1 according to the black voltage control signal 602 to generate the black screen signal BL50 and output the black screen signal BL50 to the signal line. In some embodiments, the black screen signal BL50 is used to prevent the liquid crystal in the display panel 102 from polarizing when displaying a black screen.

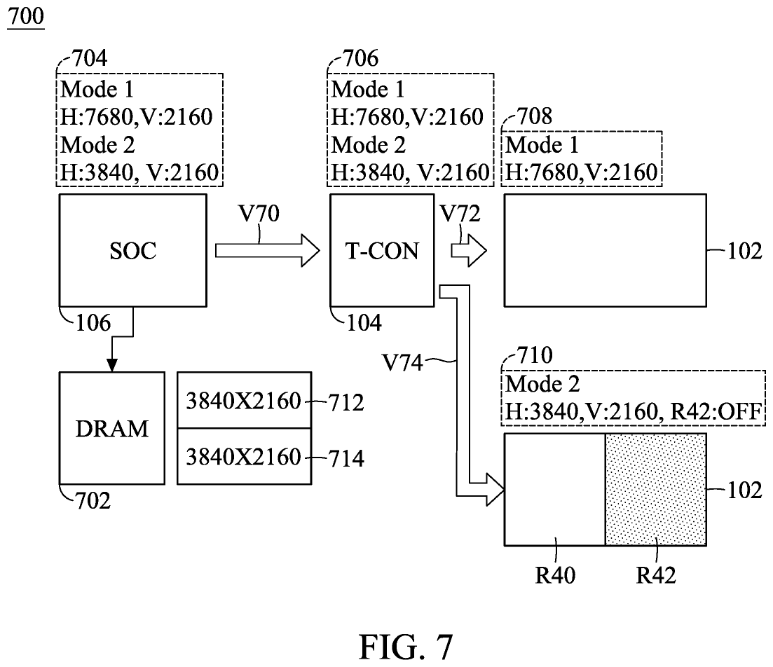

FIG. 7 is a simple schematic diagram of an electronic device 700 in accordance with some embodiments of the present disclosure. The electronic device 700 includes the display panel 102, the timing controller 104, the image processor 106, and a memory (DRAM) 702. In some embodiments, the memory 702 may be, for example, a dynamic random access memory, but the present disclosure is not limited thereto. FIG. 7 illustrates the resolution change of the image signal from the image processor 106 to the display panel 102, so the first control element group 112 and the second control element group 114 in FIG. 1 are omitted. As shown in FIG. 7, the image signal received by the image processor 106 conforms to the resolution setting 704. That is, in the first display mode (Mode 1), the horizontal resolution is 7680 and the vertical resolution is 2160 (H:7680, V:2160). In the second display mode (Mode 2), the horizontal resolution is 3840, the vertical resolution is 2160 (H:7680, V:2160). In some embodiments, the image processor 106 may store half of the resolution of the received image data in the memory 702, such as the resolution data 712 (which is 3840×2160) and the resolution data 714 (which is 3840×2160), to save storage space of the memory 702. In other words, in the first display mode (Mode 1), the image processor 106 may output an image signal V70 with the resolution of 7680×2160 to the timing controller 104. In the second display mode (Mode 2), the image processor 106 may output an image signal V70 with the resolution of 3840×2160 to the timing controller 104.

The image signal V70 conforms to the resolution setting 702. Next, the first image signal V72 or the second image signal V74 output by the timing controller 104 conforms to the resolution setting 706. That is, in the first display mode (Mode 1), the horizontal resolution of the first image signal V72 is 7680 and the vertical resolution is 2160 (H:7680, V:2160). In the second display mode (Mode 2), the horizontal resolution of the second image signal V74 is 3840 and the vertical resolution is 2160 (H: 3840, V: 2160). The timing controller 104 indirectly outputs the image signal V72 or the image signal V74 to the display panel 102. In the first display mode (Mode 1), the energy-saving mode is not turned on, and the image signal V72 conforms to the resolution setting 708, that is, the horizontal resolution is 7680 and the vertical resolution is 2160 (H:7680, V:2160). In the second display mode (Mode 2), the energy-saving mode is turned on, and the image signal V74 conforms to the resolution setting 710, that is, the horizontal resolution is 3840 and the vertical resolution is 2160 (H:3840, V:2160). The timing controller 104 outputs a control signal such that the control units corresponding to the first display area R40 are turned on, but the control units corresponding to the second display area R42 are turned off. Compared with the image signal V44 in FIG. 4, the resolution of the image signal V74 (H:3840, V:2160) in FIG. 7 output by the timing controller 104 is half of the resolution of the image signal V44 (H:7680, V:2160) in FIG. 4. Therefore, the amount of image signal data to be sent is reduced and the purpose of reducing power consumption is achieved. According to some embodiments, as shown in FIG. 7, the resolution of the first image signal V72 may be different from the resolution of the second image signal V74. For example, as shown in FIG. 7, the horizontal resolution (H: 3840) of the second image signal V74 is half of the horizontal resolution (H: 7680) of the first image signal V72.

The display panel 102 receives the image signal V72 that conforms to the resolution setting 710. Since the control units corresponding to the second display area R42 are turned off, the display panel 102 displays the corresponding image in the first display area R40 and displays a black screen in the second display area R42. The actual resolution of the image output by the display panel 102 is 3840*2160, but the present disclosure is not limited thereto. In some embodiments of FIG. 7, the image signal received by the image processor 106 may, for example, come from the vehicle control unit 206 in FIG. 2. In some embodiments of FIG. 7, the vehicle control unit 206, the image processor 106, and the timing controller 104 preset two modes, and the two modes are switched by the vehicle control unit 206. In some embodiments, the vehicle controller 206 can also operate in an energy-saving mode (for example, when the driver actively turns on the energy-saving mode), but the present disclosure is not limited thereto.

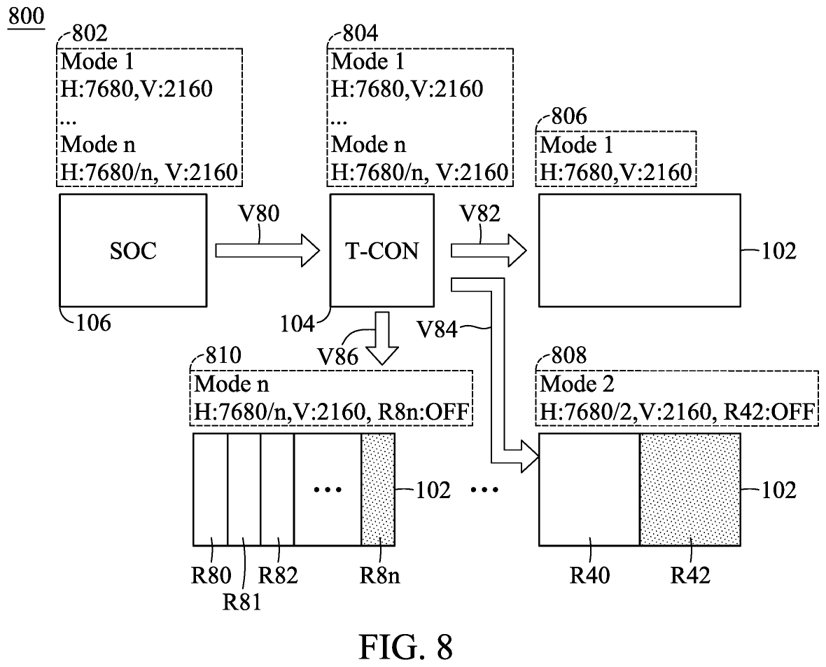

FIG. 8 is a simple schematic diagram of an electronic device 800 in accordance with some embodiments of the present disclosure. The electronic device 800 includes the display panel 102, the timing controller 104, and the image processor 106. FIG. 8 illustrates the resolution change of the image signal from the image processor 106 to the display panel 102, so the first control element group 112 and the second control element group 114 in FIG. 1 are omitted. As shown in FIG. 8, the image signal received by the image processor 106 conforms to the resolution setting 802. That is, in the first display mode (Mode 1), the horizontal resolution is 7680 and the vertical resolution is 2160 (H:7680, V:2160). In the second display mode (Mode 2), the horizontal resolution is 3840 (7680/2), the vertical resolution is 2160 (H:3840, V:2160). In the nth display mode (Mode n), the horizontal resolution is 7680/n and the vertical resolution is 2160 (H:7680/n, V:2160). n can be any positive integer. In other words, in the first display mode (Mode 1), the image processor 106 may output an image signal V80 with the resolution of 7680×2160 to the timing controller 104. In the second display mode (Mode 2), the image processor 106 may output an image signal V80 with the resolution of 3840×2160 to the timing controller 104. In the nth display mode (Mode n), the image processor 106 may output an image signal V80 with the resolution of (7680/n)×2160 to the timing controller 104.

The image signal V80 conforms to the resolution setting 802. Next, the image signal V82, the image signal V84, and the image signal V86 output by the timing controller 104 conform to the resolution setting 804. That is, in the first display mode (Mode 1), the horizontal resolution of the image signal V82 is 7680 and the vertical resolution is 2160 (H: 7680, V: 2160). In the second display mode (Mode 2), the horizontal resolution of the image signal V84 is 3840 (7680/2), and the vertical resolution is 2160 (H:3840, V:2160). In the nth display mode (Mode n), the horizontal resolution of the image signal V86 is 7680/n, and the vertical resolution is 2160 (H:7680/n, V:2160). The timing controller 104 indirectly outputs the image signal V82, the image signal V84, and the image signal V86 to the display panel 102. In the first display mode (Mode 1), the energy-saving mode is not turned on, and the image signal V82 conforms to the resolution setting 806, that is, the horizontal resolution is 7680 and the vertical resolution is 2160 (H:7680, V:2160). In the second display mode (Mode 2), the energy-saving mode is turned on, and the image signal V84 conforms to the resolution setting 808, that is, the horizontal resolution is 3840 and the vertical resolution is 2160 (H:3840, V:2160). The timing controller 104 outputs a sub-control signal such that the control units corresponding to the first display area R40 are turned on, but the control units corresponding to the second display area R42 are partially turned off. In the nth display mode (Mode n), the energy-saving mode is turned on, and the image signal V86 conforms to the resolution setting 810, that is, the horizontal resolution is 7680/n and the vertical resolution is 2160 (H: 7680/n, V:2160). The timing controller 104 outputs sub-control signals, so that the control units corresponding to the first display area R80, the second display area R82, the third display area R83, and the (n−1)th display area R8n-1 are turned on, but the control units corresponding to the nth display area R8n are partially turned off (R42:OFF).

In the second display mode (Mode 2), the display panel 102 receives the image signal V84 that conforms to the resolution setting 808. Since the control units corresponding to the second display area R42 are partially turned off, the display panel 102 displays the corresponding image in the first display area R40 and displays a black screen in the second display area R42. In some embodiments of FIG. 8, in the energy-saving mode, since the timing controller 104 reduces the amount of resolution data transmitted to the display panel 102, and at the same time, the timing controller 104 outputs sub-control signals to partially turn off the control units corresponding to the second display area R42. Therefore, the purpose of saving power consumption may be further achieved. In some embodiments of FIG. 8, the image signal received by the image processor 106 may, for example, come from the vehicle control unit 206 in FIG. 2. In some embodiments of FIG. 8, the vehicle control unit 206, the image processor 106, and the timing controller 104 preset multiple modes, the multiple modes are switched by the vehicle controller 206, and the resolution of the image signal output by the vehicle control unit 206 is changeable. In some embodiments, the image processor 106 may control the timing controller 104 to turn off part of the display area of the display panel 102, but the present disclosure is not limited thereto. The difference between FIG. 8 and FIG. 7 is that some embodiments in FIG. 8 have n display modes, while some embodiments in FIG. 7 have two display modes.

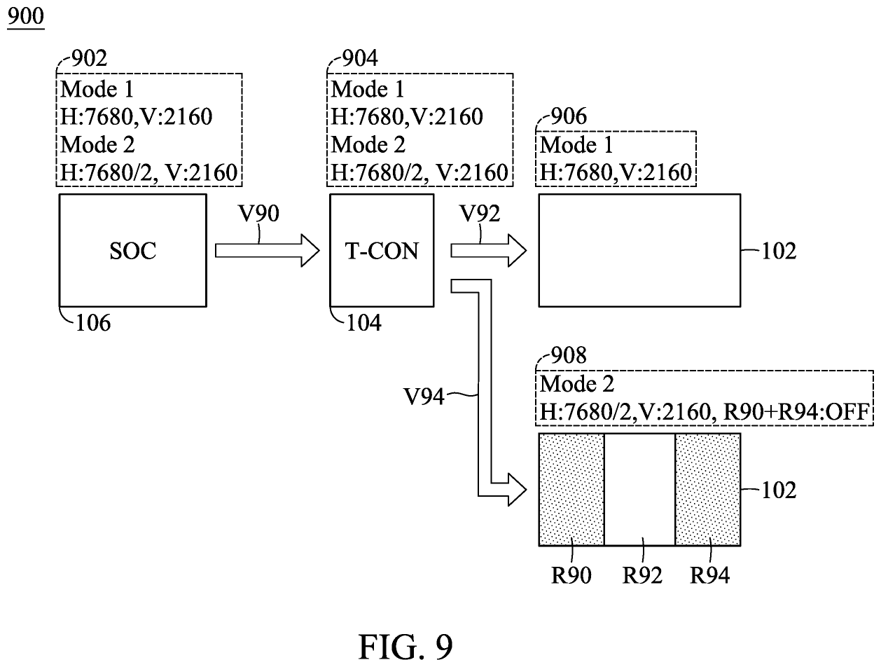

FIG. 9 is a simple schematic diagram of an electronic device 900 in accordance with some embodiments of the present disclosure. The difference between FIG. 9 and FIG. 8 is as follows. The image processor 106 outputs the image signal V90 that conforms to the resolution setting 902 to the timing controller 104. The resolution setting 902 is the same as the resolution setting 802. The timing controller 104 outputs the image signal V92 or the image signal V94 that conforms to the resolution setting 904 to the display panel 102. The resolution setting 904 is the same as the resolution setting 804. In the second display mode (Mode 2), the energy-saving mode is turned on, and the image signal V94 conforms to the resolution setting 908, that is, the horizontal resolution is 7680/2 and the vertical resolution is 2160 (H:7680/2, V:2160). The timing controller 104 outputs the sub-control signals, so that the control units corresponding to the first display area R90 are partially turned off, the control units corresponding to the second display area R92 are turned on, and the control units corresponding to the third display area R94 are partially turned off. The display panel 102 receives the image signal V94 that conforms to the resolution setting 908. Since the control units corresponding to the first display area R90 and the third display area R94 are partially turned off, the display panel 102 displays the corresponding image in the second display area R92, and displays a black screen in the first display area R90 and the third display area R94.

In some embodiments of FIG. 9, the effective display area of the display panel 102 is not limited to the leftmost or rightmost position of the display panel 102. In some embodiments of FIG. 9, the image processor 106 may control the timing controller 104 to turn off part of the display area of the display panel 102, but the present disclosure is not limited thereto. The difference between FIG. 9 and FIG. 8 is that some embodiments of FIG. 9 display the image in the center of the display 102 and has two display modes, while some embodiments of FIG. 8 display the image on the edge of the display 102 and has n display modes.

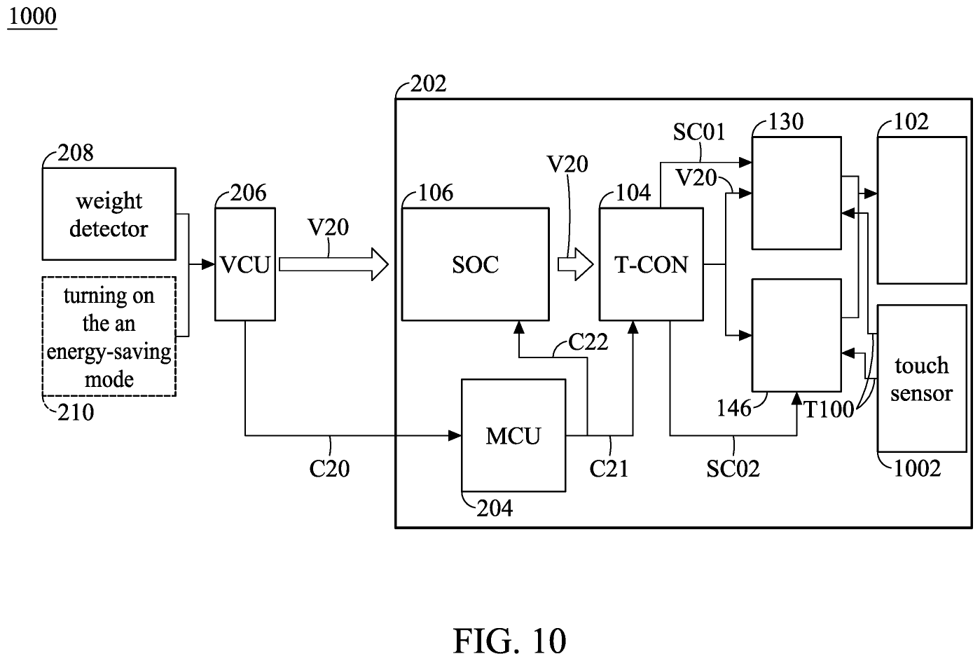

FIG. 10 is a schematic diagram of an electronic device 1000 in accordance with some embodiments of the present disclosure. The difference between FIG. 10 and FIG. 2 is as follows. The display module 202 in FIG. 10 further includes a touch sensor 1002. The touch sensor 1002 outputs a sensing signal T100 to the first control element 130 and the second control element 146 according to a sensing result. In FIG. 10, the first control element 130 and the second control element 146 may include a touch driver (not shown) for receiving the sensing signal T100 from the touch sensor 1002. In some embodiments, when the weight detector 208 detects that no one is seated and/or the energy-saving mode of the vehicle controller 206 is turned on, the timing controller 104 may output the sub-control signal SC02 to the second control element 146 to turn off the touch driver in the second control element 146 to enter the energy-saving mode for reducing power consumption.

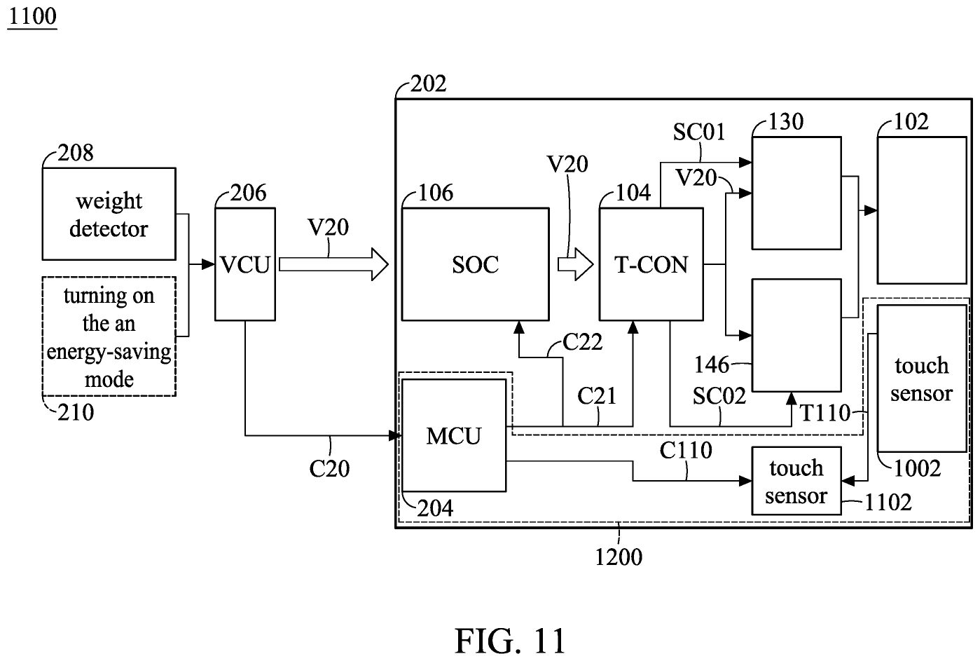

FIG. 11 is a schematic diagram of an electronic device 1100 in accordance with some embodiments of the present disclosure. The difference between FIG. 11 and FIG. 10 is as follows. The display module 202 in FIG. 10 further includes a touch driver 1102. The touch driver 1102 receives the sensing signal T110 from the touch sensor 1002. The first control element 130 and the second control element 146 in FIG. 11 may not include the touch driver. In other words, in FIG. 11, the touch driver 1102 is independent of the first control element 130 and the second control element 146. In some embodiments, at least one of the first control element 130 and the second control element 146 may include a touch driver. In some embodiments, when the weight detector 208 detects that no one is seated, and/or the energy-saving mode 210 of the vehicle control unit 206 is turned on, the third control element 204 outputs the control signal C110 to the touch driver 1102 to turn off the touch driver 1102 to enter the energy-saving mode, so that the power consumption is reduced. In some embodiments, the display module 202 in FIG. 11 includes a touch function circuit 1200. The touch function circuit 1200 includes the third control element 204, the touch driver 1102, and the touch sensor 1002.

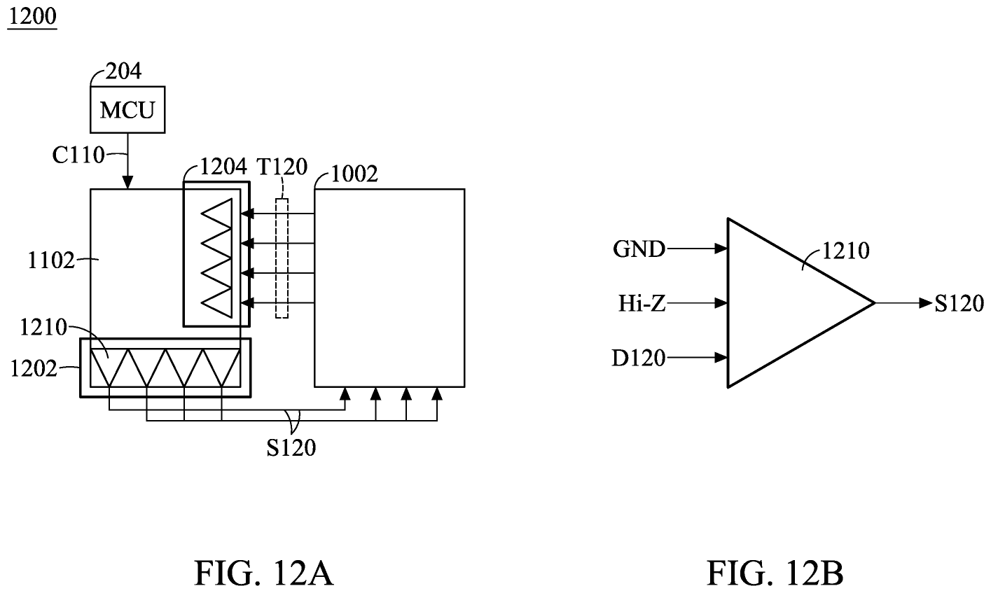

FIG. 12A is a schematic diagram of a touch function circuit 1200 in the electronic device 1100 in FIG. 11 in accordance with some embodiments of the present disclosure. As shown in FIG. 12A, the touch function circuit 1200 of the electronic device 1100 in FIG. 11 includes the third control element 204, the touch driver 1102, and the touch sensor 1002. FIG. 12A illustrates how the third control element 204 turns off the touch driver 1102. The touch driver 1102 includes a transmitting buffer group 1202 and a receiving buffer group 1204. The transmitting buffer group 1202 may, for example, include a transmitting buffer 1210, but the present disclosure is not limited thereto. In some embodiments, when the energy-saving mode is turned on, the third control element 204 outputs the control signal C110 to the touch driver 1102. After receiving the control signal C110, the touch driver 1102 sets the touch drive signal S120 that outputs itself to a high impedance state to save power consumption. In some embodiments, when the energy-saving mode is turned on, after receiving the control signal C110, the touch driver 1102 disables the receiving buffer group 1204, so that the touch driver 1102 does not receive the sensing signal T120 from the touch sensor 1002 to save power consumption.

FIG. 12B is a schematic diagram of a transmit buffer 1210 in accordance with some embodiments of the present disclosure. As shown in FIG. 12B, the transmitting buffer 1210 includes a first receiving end, a second receiving end, a third receiving end, and an output end. The first receiving end receives a ground signal GND. The second receiving end receives a high impedance signal Hi-Z. The third receiving end receives a normal touch driving-signal D120. When the energy-saving mode is turned on, a signal S120 output by the transmitting buffer 1210 at the output end is equal to the high impedance signal Hi-Z. When the energy-saving mode is not enabled, the signal S120 output by the transmitting buffer 1210 at the output end is equal to the touch-driving signal D120.

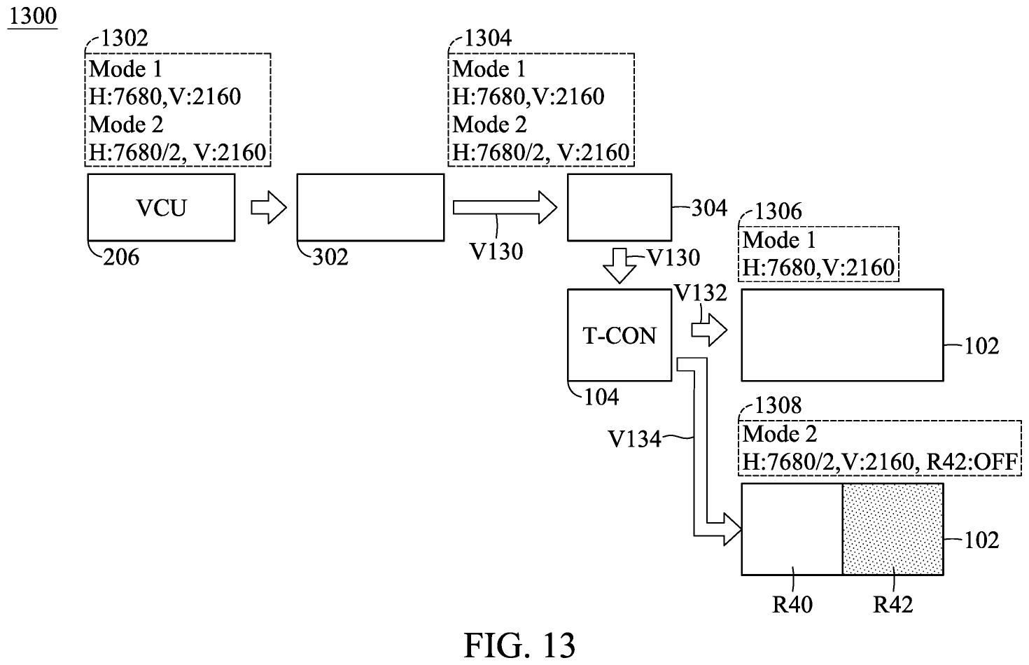

FIG. 13 is a simple schematic diagram of an electronic device 1300 in accordance with some embodiments of the present disclosure. The electronic device 1300 includes the vehicle control unit 206, the display panel 102, the timing controller 104, the serializer 302, and the deserializer 304. FIG. 13 illustrates the resolution change of the image signal from the vehicle control unit 206 to the display panel 102, so the first control element group 112 and the second control element group 114 in FIG. 1 are omitted. As shown in FIG. 13, the image signal V130 output by the vehicle control unit 206 conforms to the resolution setting 1302. That is, in the first display mode (Mode 1), the horizontal resolution is 7680 and the vertical resolution is 2160 (H:7680, V:2160). In the second display mode (Mode 2), the horizontal resolution is 7680/2 and the vertical resolution is 2160 (H:7680/2, V:2160). Next, the image signal V130 undergoes encoding by the serializer 302 and decoding by the deserializer 304, and is received by the timing controller 104. The image signal V130 received by the timing controller 104 conforms to the resolution setting 1304. The resolution setting 1304 is the same as the resolution setting 1302. In other words, in the first display mode (Mode 1), the deserializer 304 may output the image signal V130 with a resolution of 7680×2160 to the timing controller 104. In the second display mode (Mode 2), the deserializer 304 may output the image signal V130 with a resolution of (7680/2)×2160 to the timing controller 104.

Next, the image signal V132 or the image signal V134 output by the timing controller 104 conforms to the resolution setting 1304. That is, in the first display mode (Mode 1), the horizontal resolution is 7680 and the vertical resolution is 2160 (H:7680, V:2160). In the second display mode (Mode 2), the horizontal resolution is 7680/2 and the vertical resolution is 2160 (H:7680/2, V:2160). The timing controller 104 indirectly outputs the image signal V132 or the image signal V134 to the display panel 102. In the first display mode (Mode 1), the energy-saving mode is not turned on, and the image signal V132 conforms to the resolution setting 1306, that is, the horizontal resolution is 7680 and the vertical resolution is 2160 (H:7680, V:2160). In the second display mode (Mode 2), the energy-saving mode is turned on, and the image signal V134 conforms to the resolution setting of 1308, that is, the horizontal resolution is 7680/2 and the vertical resolution is 2160 (H:7680/2, V:2160). The timing controller 104 outputs a sub-control signal such that the control units corresponding to the first display area R40 are turned on, but the control units corresponding to the second display area R42 are partially turned off.

The display panel 102 receives the image signal V134 that conforms to the resolution setting 1308. Since the control units corresponding to the second display area R42 are partially turned off, the display panel 102 displays the corresponding image in the first display area R40 and displays a black screen in the second display area R42. In some embodiments of FIG. 13, in the energy-saving mode, since the timing controller 104 reduces the amount of resolution data transmitted to the display panel 102, and at the same time, the timing controller 104 outputs sub-control signals to turn off the control units corresponding to the second display area R42. Therefore, the purpose of saving power consumption is achieved. In some embodiments of FIG. 13, the vehicle control unit 206 may control the timing controller 104 through the serializer 302 and the deserializer 304 whether to turn off part of the display area of the display panel 102, but the present disclosure is not limited thereto. In some embodiments of FIG. 13, the vehicle control unit 206 may control the switching frequency between the first display mode (Mode 1) and the second display mode (Mode 2) to reduce the amount of resolution data and reduce bandwidth occupation.

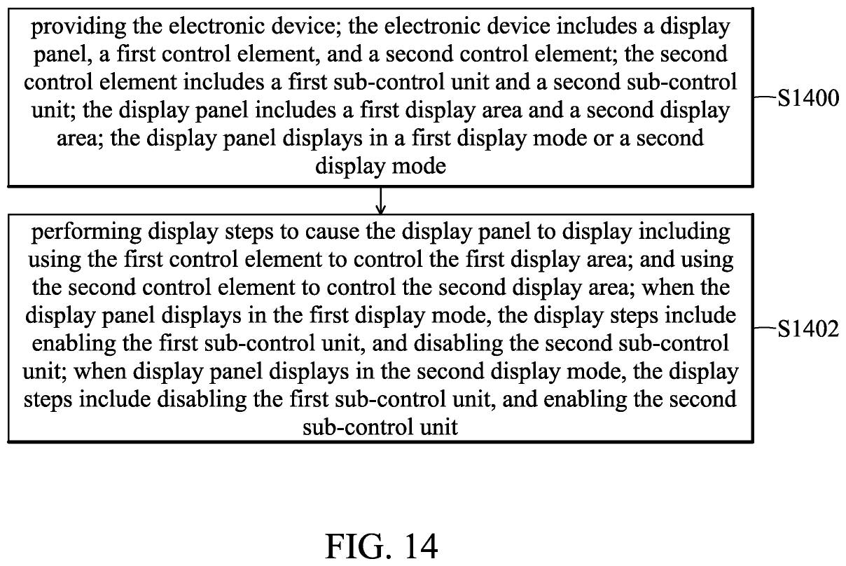

FIG. 14 is a flow chart of a method for controlling an electronic device in accordance with some embodiments of the present disclosure. As shown in FIG. 14 (please refer to FIG. 1 and FIG. 5 at the same time), the electronic device includes the display panel 102, the first control element 130, and the second control element 146. The second control element 146 includes the first sub-control unit 550 and the second sub-control unit 552. The display panel 102 includes a first display area and a second display area. The display panel displays in a first display mode or a second display mode (S1400). The present disclosure performs the steps to cause the display panel to display, which includes the following stages. The first control element is used to control the first display area. The second control element is used to control the second display area. When the display panel displays in the first display mode, the display steps include the following stage. The first sub-control unit is enabled and the second sub-control unit is disabled. When the display panel displays in the second display mode, the display steps include the following stage. The first sub-control unit is disabled and the second sub-control unit is enabled (S1402). In some embodiments, steps S1400 and S1402 are performed by the timing controller 104 in FIG. 1.

In some embodiments, the method for controlling electronic device of the present disclosure further includes the following stages. It is detected whether there is someone sitting in the seat corresponding to the second display area R2. When it is detected that someone is seated, the display panel is displayed in the first display mode. When it is detected that no one is seated, the display panel is displayed in the second display mode. When the display panel of the present disclosure is a vehicle display panel, the electronic device can be a vehicle. In this case, the second display area R2 of the display panel may be a display area corresponding to the front of the passenger seat. Specifically, when it is detected that no one is seated in the passenger seat, the display panel may be switched to the second display mode, and at least one control unit in the second control element 146 used to control the second display area R2 may be disabled. In the above embodiments, as shown in FIG. 5, the first sub-control unit 550 in the second control element 146 for controlling the second display area R2 may be disabled. In this way, the effect of power saving can be achieved.

In some embodiments, the aforementioned detecting step can be performed using the weight detector 208 in FIG. 2. In some embodiments, the method for controlling electronic device of the present disclosure further includes the following stages. When the display panel displays in the first display mode, the first image signal V42 is output to the display panel 102. When the display panel displays in the second display mode, the second image signal V44 is output to the display panel 102. As shown in FIG. 4, the first image signal V42 is different from the second image signal V44. In this way, the display panel 102 has different images in the first and second display modes. Specifically, in the first display mode, both the first area and the second area of the display panel 102 display images. In the second display mode, the first area R40 of the display panel 102 display an image, but the second area R42 does not display an image. According to some embodiments, the first image signal V42 and the second image signal V44 may be provided by the timing controller 104.

According to some embodiments, in addition to the above-mentioned switching of the display panel to the second display mode based on the detection result, the second display mode can also be actively set. Specifically, the method of the present disclosure may include the following stages. The electronic device is set to an energy-saving mode so that the display panel displays in the second display mode. Specifically, the user can actively turn on the energy-saving mode so that the display panel displays in the second display mode. For example, when the display panel is a vehicle display panel and the electronic device is a vehicle, as shown in FIG. 2, the vehicle control unit 206 may execute the energy-saving mode. The user can actively turn on the energy-saving mode. For example, the driver can press a physical button or press an instruction screen on the touch display panel to actively turn on the energy-saving mode. In this way, the vehicle control unit 206 receives the notification signal A01 (signal for turning on the energy-saving mode), and outputs the control signal C20 to the third control element 204 in the display module 202. Therefore, the display module 202 is informed to activate the energy-saving mode, so that the display panel 102 switches to the second display mode.

To sum up, according to some embodiments, the display panel has a first display area and a second display area. A second control element is used to control the second display area. The second control element includes a first sub-control unit and a second sub-control unit. When the display panel displays in the second display mode, the first sub-control unit is disabled and the second sub-control unit is enabled. According to some embodiments, the first sub-control unit may include a digital-to-analog converter. In this way, in the second display mode, since the functions of some circuit units in the second control element are turned off, the purpose of power saving may be achieved.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a display panel, having a first display area and a second display area; wherein the display panel is configured to display in a first display mode or a second display mode;
a first control element, configured to control the first display area; and
a second control element, configured to control the second display area; wherein the second control element comprises a first sub-control unit and a second sub-control unit;
wherein when the display panel displays in the second display mode, the first sub-control unit is disabled, and the second sub-control unit is enabled.

2. The electronic device as claimed in claim 1, wherein the first sub-control unit of the second control element comprises a digital-to-analog converter.

3. The electronic device as claimed in claim 1, wherein when the display panel displays in the second display mode, the second sub-control unit generates a black screen signal.

4. The electronic device as claimed in claim 1, further comprising:
a timing controller, electrically connected to the display panel; wherein,
when the display panel displays in the first display mode, the timing controller is configured to output a first image signal to the display panel;
when the display panel displays in the second display mode, the timing controller is configured to output a second image signal to the display panel;
the first image signal is different from the second image signal.

5. The electronic device as claimed in claim 4, wherein the resolution of the first image signal is the same as the resolution of the second image signal.

6. The electronic device as claimed in claim 4, wherein the resolution of the first image signal is different from the resolution of the second image signal.

7. The electronic device as claimed in claim 4, further comprising:
an image processor, electrically connected to the timing controller, configured to send an image signal to the timing controller;
wherein the image signal comprises the first image signal and the second image signal.

8. The electronic device as claimed in claim 4, further comprising:
a third control element, electrically connected to the timing controller, configured to output a control signal to the timing controller;
wherein the timing controller outputs a sub-control signal to the second control element according to the control signal, so that the first sub-control unit is disabled and the second sub-control unit is enabled in the second display mode.

9. The electronic device as claimed in claim 1, wherein the first control element comprises a receiving interface, a digital-to-analog convertor, a switch, and a buffer.

10. The electronic device as claimed in claim 1, wherein the first sub-control unit in the second control element comprises a receiving interface.

11. The electronic device as claimed in claim 1, wherein the second sub-control unit in the second control element comprises a switch, a buffer, and a black voltage generator.

12. The electronic device as claimed in claim 4, wherein the timing control includes a transmitting interface and a register, and the transmitting interface comprises an enable terminal.

13. The electronic device as claimed in claim 12, wherein when the display panel displays in the second display mode, the register outputs a control signal to the enable terminal of the transmitting interface, so that the transmitting interface is turned off.

14. The electronic device as claimed in claim 7, further comprising:
a memory, electrically connected to the image processor;
wherein the image processor stores half of resolution data of the image signal in the memory.

15. The electronic device as claimed in claim 11, wherein the black voltage generator generates a black screen signal.

16. The electronic device as claimed in claim 15, wherein when the display panel displays in the second display mode, the black screen signal is output to the second display area of the display panel.

17. A method for controlling an electronic device, comprising:
providing the electronic device; wherein the electronic device comprises a display panel, a first control element, and a second control element; the second control element comprises a first sub-control unit and a second sub-control unit; the display panel comprises a first display area and a second display area; the display panel displays in a first display mode or a second display mode; and
performing display steps to cause the display panel to display, comprising:
using the first control element to control the first display area;
using the second control element to control the second display area;
wherein when the display panel displays in the first display mode, the display steps, comprise:
enabling the first sub-control unit, and disabling the second sub-control unit;
wherein when the display panel displays in the second display mode, the display steps, comprise:
disabling the first sub-control unit, and enabling the second sub-control unit.

18. The method as claimed in claim 17, further comprising:
detecting whether there is a person sitting in a seat corresponding to the second display area;
causing the display panel to display in the first display mode when it is detected that there is the person sitting in the seat;
causing the display panel to display in the second display mode when it is detected that there is no person sitting in the seat.

19. The method as claimed in claim 17, further comprising:
setting the electronic device to an energy-saving mode so that the display panel displays in the second display mode.

20. The method as claimed in claim 17, further comprising:
outputting a first image to the display panel when the display panel displays in the first display mode; and
outputting a second image to the display panel when the display panel displays in the second display mode;
wherein the first image signal is different from the second image signal.
